(19) United States
(12) Patent Application Publication
(10) Pub. No.: US 2026/0098801 A1
(43) Pub. Date: Apr. 9, 2026

(54) IN-LINE VARIABLE PATHLENGTH SPECTROPHOTOMETER

(71) Applicant: HDI Patents LLC, Portsmouth, NH (US)

(72) Inventor: Holly Dyer, Dover, NH (US)

(21) Appl. No.: 18/905,668

(22) Filed: Oct. 3, 2024

(51) Int. Cl. G01N 21/31

(52) U.S. Cl. CPC G01N 21/31; G01N 2021/3125; G01N 2201/0666

(57) ABSTRACT

The present disclosure relates to an in-line variable pathlength spectrophotometer. Currently, at-line spectrophotometers are used to measure the concentration of substances in a liquid during manufacturing of various formulations. Since manufacturing needs to be paused for at-line measurements, at-line spectrophotometers create an undesirable overhead. An in-line spectrophotometer is attached to the bioreactor and measures the concentration of substances in the liquid contained in the bioreactor in real-time, without any need to pause manufacturing. Moreover, the pathlength of the spectrophotometer, namely the distance light travels through the measured liquid, may be adjustable. Hence, measurements may be taken multiple times with varied pathlength so that accuracy of measurements may be enhanced. In one embodiment, the spectrophotometer may rotate about a central axis of the bioreactor to minimize disturbance to the homogeneity of the liquid. In another embodiment, the spectrophotometer may be attached to a port on an inner wall of the bioreactor.

### TECHNICAL FIELD

The present disclosure relates to the field of spectrophotometry.

### BACKGROUND

Spectrophotometers are widely used in analytical chemistry and biochemistry for quantitative analysis of substances. They measure the absorbance or transmission of light by a sample at specific wavelengths, allowing scientists to determine the concentration of the target substance being studied. This concentration is typically correlated with the amount of light absorbed by the sample, based on the Beer-Lambert law, which provides:

$$A = ε LC$$

wherein, A represents the absorbance, & represents the molar extinction coefficient of the target substance, L represents the pathlength the light travels through the sample, and C represents the concentration of the target substance.

During the manufacturing of monoclonal antibodies (mAbs) and many other formulations, the concentrations of substances in the liquid need to be constantly monitored. The state-of-the-art technologies use at-line spectrophotometers; that is, a sample of liquid is taken out of the bioreactor for measurement. The problem with at-line measurement is that it creates an overhead in the manufacturing process, given that all work needs to be paused while measuring the sample with an at-line spectrophotometer.

Hence, an in-line spectrophotometer, which is a spectrophotometer that is integrated with the bioreactor and can measure the concentration of a target chemical in the solution in real-time, may be introduced to facilitate the manufacturing process of formulations.

Furthermore, bioreactors are often large and expensive. Hence, having an in-line spectrophotometer able to be detachably connected to an existing, state-of-the-art bioreactor can save costs.

### SUMMARY

The present disclosure teaches an in-line variable pathlength spectrophotometer, comprising: a light source, to emit a first light; an entrance slit, to provide a narrow opening for the first light to pass; a monochromator, to separate the first light and generate a plurality of lights with different wavelengths; a wavelength selector, to select a second light with a narrow range of wavelengths from the plurality of lights with different wavelengths; wherein, the narrow range of wavelengths is selected based on a target substance whose concentration is to be measured; a photodetector, to measure an absorbance of the second light by a sample of liquid; wherein, the sample of liquid is placed in between the wavelength selector and the photodetector; wherein, a concentration of the target substance in the sample of liquid is deduced from the absorbance; wherein, the photodetector is movable along a direction of the second light, so that a distance the second light travels through the sample of liquid, which is a pathlength of the spectrophotometer, is adjustable.

In some embodiments, the presently disclosed spectrophotometer is detachably attached to a port located on an inner surface of a top or a side wall of the bioreactor.

In some embodiments, the presently disclosed spectrophotometer is detachably attached to a port located on an inner wall of a pathway of the bioreactor.

In some embodiments, the presently disclosed variable pathlength spectrophotometer further comprises a chamber with two or more ends, allowing the sample of liquid to enter and exit the chamber.

In some embodiments, the presently disclosed spectrophotometer is disposable.

In some embodiments, a width of the entrance slit is adjustable.

In some embodiments, a reading of the spectrophotometer is displayed on a screen connected to the spectrophotometer in real-time.

In some embodiments, a reading of the spectrophotometer is sent to a computing device via wireless or wired connection in real-time.

In some embodiments, the light source, the entrance slit, the monochromator, the wavelength selector, the chamber, and the photodetector are placed along an axis.

The presently disclosed technology further teaches a bioreactor, comprising: a container, to hold a liquid; wherein, the liquid includes a target substance; an agitator located inside the container, to stir and mix the liquid; a variable pathlength spectrophotometer attached to or placed in the bioreactor, including: a light source, to emit a first light; an entrance slit, to provide a narrow opening for the first light to pass; a monochromator, to separate the first light and generate a plurality of lights with different wavelengths; a wavelength selector, to select a second light with a narrow range of wavelengths from the plurality of lights with different wavelengths; wherein, the narrow range of wavelengths is selected based on a target substance whose concentration is to be measured; a photodetector, to measure an absorbance of the second light by a sample of liquid; wherein, the sample of liquid takes up a space between the wavelength selector and the photodetector; wherein, the concentration of the target substance in the sample of liquid is deduced from the absorbance; wherein, the photodetector is movable along a direction of the second light, so that a distance the second light travels in the sample of liquid, which is a pathlength of the spectrophotometer, is adjustable.

In some embodiments, the bioreactor further includes one or more sensors attached to one or more ports located on an inner surface of a top or a side wall of the container to respectively measure one or more attributes of the liquid.

In some embodiments, the variable pathlength spectrophotometer is detachably attached to a port located on an inner surface of a top or a side wall of the container.

In some embodiments, the variable pathlength spectrophotometer is disposable or has disposable parts.

In some embodiments, the bioreactor further comprises a screen, wherein a reading of the variable pathlength spectrophotometer is displayed on the screen or sent to a computing device via wireless or wired connection.

In some embodiments, the target substance is monoclonal antibodies (mAbs).

In some embodiments, the container includes a pathway; a portion of the liquid passes through the pathway; the variable pathlength spectrophotometer is attached to a port located on an inner surface of the pathway.

In some embodiments, the variable pathlength spectrophotometer is immersed in the liquid and rotates about a first central axis of the container.

In some embodiments, the variable pathlength spectrophotometer includes a first enclosure housing the light source, the entrance slit, the monochromator, and the wavelength selector, wherein the liquid is not able to enter the first enclosure.

In some embodiments, a second central axis of the variable pathlength spectrophotometer is aligned with a radius of the container.

In some embodiments, a second central axis of the variable pathlength spectrophotometer is vertical.

In some embodiments, the variable pathlength spectrophotometer further includes a chamber with two or more ends, allowing the sample of liquid to enter and exit the chamber.

In some embodiments, the variable pathlength spectrophotometer may be of various sizes, based on the size of the bioreactor the spectrophotometer to be used with.

### BRIEF DESCRIPTION OF THE DRAWINGS

The present disclosure is further illustrated by way of exemplary embodiments, which are described in detail through the accompanying drawings. These embodiments are not limiting, and in these embodiments, the same numbering indicates the same structure, wherein:

FIG. 1 is a structural diagram of a bioreactor with an in-line spectrophotometer, according to a first exemplary embodiment of the presently disclosed technology.

FIG. 2 is a structural diagram of a bioreactor with an on-line spectrophotometer, according to some embodiments of the presently disclosed technology.

FIG. 3 is a diagram describing the detailed structure of the in-line variable pathlength spectrophotometer, according to some embodiments of the presently disclosed technology.

FIG. 4A is a side-view structural diagram of the bioreactor with the in-line spectrophotometer, according to a second exemplary embodiment of the presently disclosed technology.

FIG. 4B is a top-view structural diagram of the bioreactor with the in-line spectrophotometer, according to the second exemplary embodiment of the presently disclosed technology.

FIG. 4C is a side-view structural diagram of the bioreactor with the in-line spectrophotometer, according to a variation of the second exemplary embodiment of the presently disclosed technology.

### DETAILED DESCRIPTION

In order to more clearly illustrate the technical solutions of the embodiments of the present disclosure, the accompanying drawings for the description of the embodiments are described below. Obviously, the accompanying drawings in the following description are only some examples or embodiments of the present disclosure, and it is possible for a person of ordinary skill in the art to apply the present disclosure to other similar scenarios in accordance with these accompanying drawings without creative labor. Unless obviously obtained from the context or the context illustrates otherwise, the same numeral in the drawings refers to the same structure or operation.

It should be understood that the terms “system,” “device,” “unit,” and/or “module” are used herein as a way to distinguish between different components, elements, parts, sections, or assemblies at different levels. However, if other words may achieve the same purpose, the terms may be replaced with alternative expressions.

As indicated in the present disclosure and in the claims, unless the context clearly suggests an exception, the words “one,” “a,” “a kind of,” and/or “the” do not refer specifically to the singular but may also include the plural. In general, the terms “include” and “comprise” suggest only the inclusion of clearly identified steps and elements, which do not constitute an exclusive list, and the method or device may also include other steps or elements.

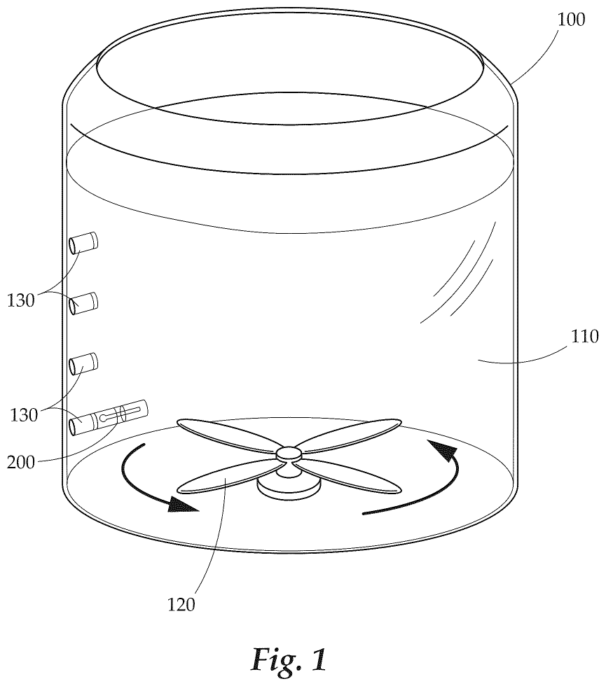

FIG. 1 is a structural diagram of a bioreactor with an in-line spectrophotometer, according to a first exemplary embodiment of the presently disclosed technology. The bioreactor may be used for the manufacturing of monoclonal antibodies (mAbs) or other formulations.

As shown in FIG. 1, the main element of a bioreactor may be a container 100. The container 100 may be at-scale or lab-scale. An at-scale container 100 may be for industrial usage, which may have a volume of 5,000 L to 20,000 L. The at-scale container 100 may also be used for practice runs after lab-scale studies are complete. A lab-scale container 100 may be much smaller in size, which may be used for testing in the lab while preparing for at-scale runs or troubleshooting issues happening at the at-scale level.

The container 100 may be filled with liquid 110. The liquid 110 may be an mAbs formulation, other formulations, or any intermediate solution acquired during the manufacturing stages thereof before reaching the final purified and formulated product.

An agitator 120 may be positioned inside the container 100 for mixing the liquid 110 continuously. This process of agitation could enhance the homogeneity of the liquid 110 in terms of concentration, temperature, pH level, etc., and could facilitate chemical reactions. In some embodiments, the agitator 120 may be placed at the bottom of the container 100. In some embodiments, the size of the agitator 120 may be sufficiently large for stirring and mixing the liquid 110 thoroughly. In some embodiments, the time and intensity of the agitation process may be adjusted according to the specific needs of manufacturing or testing.

In some embodiments, one or more ports 130 may be positioned inside the container 100. One or more sensors 131 and/or a spectrophotometer 200 may be attached to the one or more ports 130 (in a broad sense, a spectrophotometer may also be viewed a sensor). The sensors 131 may monitor the concentration, temperature, pH level, or other chemical and physical properties of the liquid 110. In some embodiments, such monitoring may be done in real-time without disruptions to the manufacturing process. In some embodiments, data gathered by the sensors 131 may be sent to a server via wired or wireless connections, and/or displayed on an integral screen of the bioreactor. In some embodiments, such data may be fed to a controller, which in turn may control the operation of the agitator accordingly. In some embodiments, the presently disclosed in-line spectrophotometer may also be implemented as one of the sensors 131. In some embodiments, the sensors 131 be either be detachably attached to the ports 130, or integrated with the container 100 via the ports.

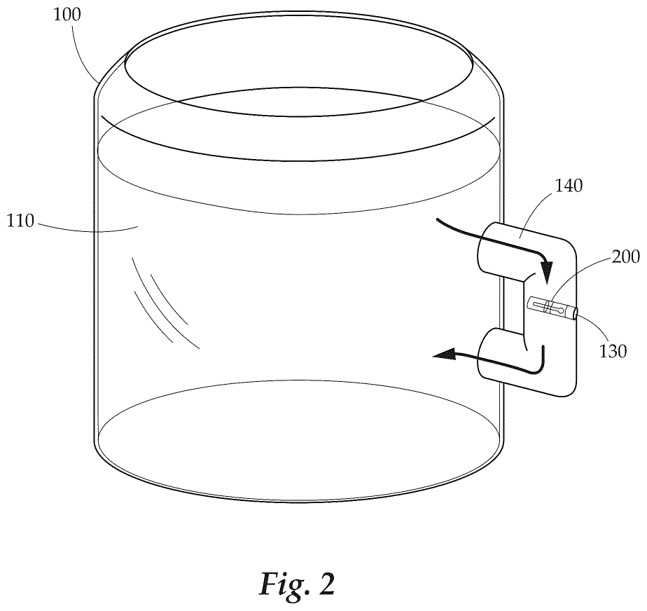

FIG. 2 is a structural diagram of a bioreactor with an on-line spectrophotometer, according to some embodiments of the presently disclosed technology.

An on-line spectrophotometer is a variation of an in-line spectrophotometer, which may also measure the concentration of a target substance in the liquid 110 in real-time. The target substance may be mAbs or other substances. As shown in FIG. 2, a pathway 140 may be attached to a side of the container 100, which may allow a small portion of the liquid 110 to pass by. An on-line spectrophotometer 200 may be attached to an inner wall of the pathway 140 via a port 130, which may monitor the concentration of the target substance in real-time. Compared to an in-line spectrophotometer, an on-line spectrophotometer may be less affected by intense centrifugal forces generated by the agitator 120. Hence, the sample of liquid 110 measured by the spectrophotometer may have a higher level of homogeneity, which improves the accuracy of measurements. Besides the on-line spectrophotometer, other sensors 131, such as a temperature sensor and a pH sensor, may also be attached to an inner wall of the pathway 140 or placed elsewhere in the container 100.

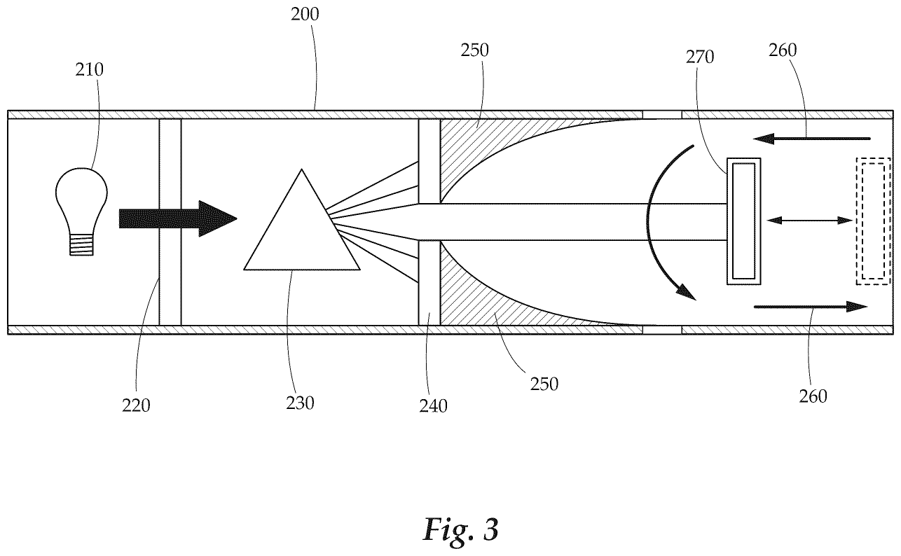

FIG. 3 is a diagram describing the detailed structure of the in-line variable pathlength spectrophotometer, according to some embodiments of the presently disclosed technology.

In some embodiments, the spectrophotometer 200 may include a light source 210. Wherein, the light source 210 may be LEDs, arc-lamps with either xenon or mercury, laser diodes or tungsten halogen lamps, or any combinations thereof.

An entrance slit 220 may be placed next to the light source 210. Wherein, the entrance slit 220 may provide a narrow opening for light from the light source 210 to pass. By adjusting the width of the entrance slit, a user can control the resolution and sensitivity of the spectrophotometer. Wider slits allow more light to enter, which increases the signal but decreases the resolution, while narrower slits provide higher resolution but lower signal intensity.

In some embodiments, the spectrophotometer 200 may include a monochromator 230 next to the entrance slit 220. Wherein, the monochromator 230 may separate different wavelengths of light from the light source 210.

In some embodiments, the spectrophotometer 200 may include a wavelength selector 240 next to the monochromator 230. Wherein, the wavelength selector 240 may select and isolate a narrow range of wavelengths from a broader spectrum of light generated by the monochromator 230. The selected range of wavelengths may be based on the type of target substance. The wavelength selector 240 may be implemented as a grating, a prism, an interference filter, an acousto-optic tunable filter (AOTF), a Fabry-Perot Interferometer, etc.

The spectrophotometer 200 may include a chamber 260 next to the wavelength selector 240. In some embodiments, the chamber 260 may be shaped as a cylindrical tube with two or more openings, wherein the two or more openings may be submerged in the liquid 110 in the container 100, so that the chamber 260 may be filled with a sample of the liquid for measurement. In some embodiments, the two or more openings may be placed on a side wall of the chamber. In some embodiments, one end of the chamber 260 adjacent to the wavelength selector 240 may contain a barrier 250. As illustrated by FIG. 3, the barrier 250 may have an elliptical shape, so that the sample of liquid 110 in the chamber 260 may also adapt to the elliptical shape at the second end of the chamber. Hence, the barriers 250 may prevent the sample of liquid 110 from having homogeneity, flow, or pressure buildup issues. In some embodiments, another end of the chamber 260, which is the faraway end from the wavelength selector 240, may be closed.

A photodetector 270 may be positioned inside the chamber 260. The photodetector 270 may be a photomultiplier tube (PMT), photodiode, or charge-coupled device (CCD). When light passes through a liquid sample, some of it may be absorbed by the sample while the rest is transmitted. The photodetector 270 may measure the absorption of light by the liquid 110, by detecting the intensity of transmitted light through the liquid. The concentration of the target substance may be deduced from the absorption of light by the liquid 110, according to the Beer-Lambert law.

Alternatively, in some embodiments, the photodetector 270 may be a reflectance detector and may measure the light that is reflected off the surface of the sample of liquid 110. The concentration of the target substance may also be deduced from the reflectance.

In some embodiments, the photodetector 270 may be kept dry and protected by glass or fiberglass.

In some embodiments, the light source 210, the entrance slit 220, the monochromator 230, the wavelength selector 240, the chamber 260, the photodetector 270, may be aligned along an axis. In some embodiments, the photodetector may move along the axis, so that a distance between the photodetector 270 and the second end of the chamber 260, in other words, the pathlength, which is the distance the light travels through the sample of liquid 110, may be adjustable. In some embodiments, measurements may be taken multiple times with varied pathlengths so that the accuracy of measurements may be enhanced.

In some embodiments, the light source 210, the entrance slit 220, the monochromator 230, the wavelength selector 240, the chamber 260, the photodetector 270, may not be aligned along an axis. In these embodiments, one or more mirrors may be placed along the light path to change the direction of the light.

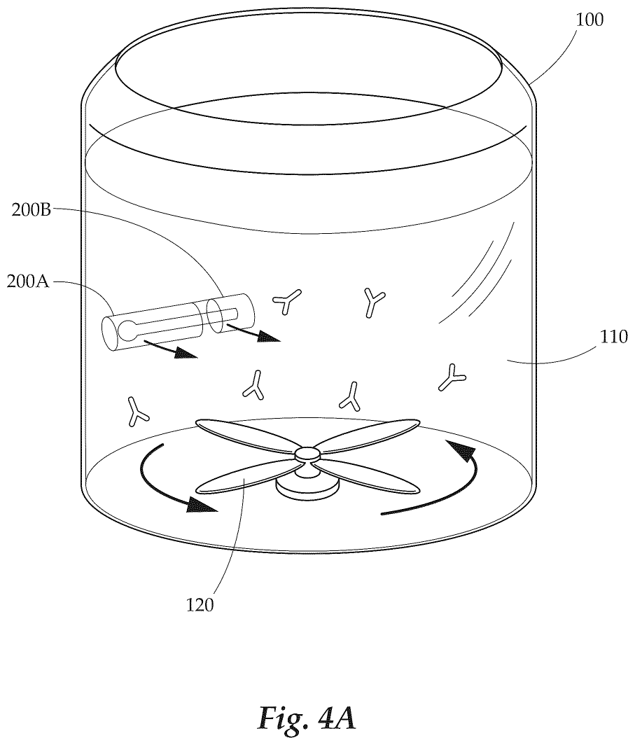

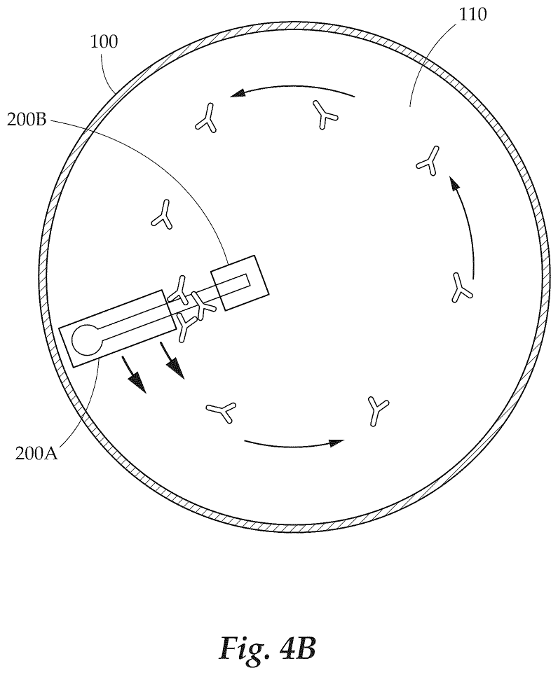

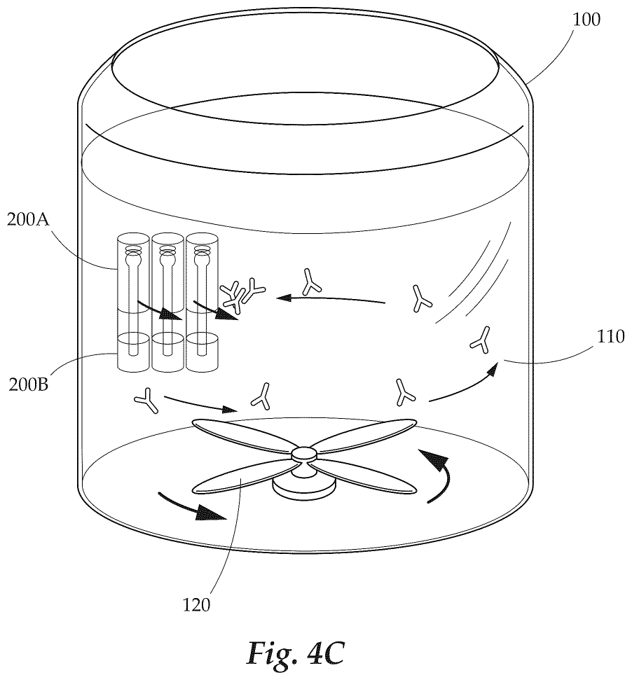

FIGS. 4A and 4B are respectively, a side-view and a top-view structural diagrams of the bioreactor with the in-line spectrophotometer, according to the second exemplary embodiment of the presently disclosed technology. FIG. 4C describes a variation thereof.

As illustrated by FIGS. 4A and 4B, in the second exemplary embodiment, the spectrophotometer 200 may be immersed in the body of liquid 110 and rotate about a central axis of the container 100, with respect to the stationary container. Hence, the body of liquid 110 may rotate about a central axis of the container 100 with respect to the spectrophotometer 200. This arrangement could minimize any disturbance to the homogeneity of the liquid 110 caused by the addition of the spectrophotometer 200.

In some embodiments, the spectrophotometer 200 may consist of two parts 200A and 200B. In some embodiments, the first part 200A may comprise the light source 210, the entrance slit 220, the monochromator 230, and the wavelength selector 240, as discussed above, placed in an enclosure so that the liquid 110 cannot enter the enclosure and potentially extend the true pathlength of light. In some embodiments, the second part 200B may include the photodetector 270 as discussed above. In some embodiments, the liquid 110 may pass between the two parts 200A and 200B of the spectrophotometer 200. In some embodiments, the two parts 200A and 200B may be connected by one or more walls, wherein the one or more walls may have gaps in between and not form a full enclosure over the space between the two parts 200A and 200B, allowing liquid to pass through and occupy said space, forming a sample. In some embodiments, the two parts 200A and 200B may be connected by one or more guide rails, and liquid may pass through the gaps between the one or more guide rails. In some embodiments, the second part 200B may move along the guide rails, so that the distance between the first part 200A and the second part 200B, namely the pathlength, may be adjusted. As discussed above, multiple measurements with different pathlengths may be taken for accuracy purposes.

In some embodiments, as illustrated by FIGS. 4A and 4B, a central axis of the spectrophotometer 200 may be aligned with a radius of the chamber 100. In some other embodiments, as illustrated by FIG. 4C, a central axis of the spectrophotometer 200 may be vertical. In some other embodiments, as illustrated by FIG. 4C, multiple vertically placed spectrophotometers 200 may be stacked together and take multiple measurements, for accuracy purposes. These multiple spectrophotometers 200 may have the same pathlength or different pathlengths.

In some embodiments, the spectrophotometer 200 may be detachably attached to an existing, state-of-the-art bioreactor to save costs.

In some embodiments, the size of the spectrophotometer 200 may vary according to the dimensions of the bioreactor.

Furthermore, unless explicitly stated in the claims, the use of order, numbers, letters, or other names for processing elements and sequences is not intended to limit the order of the processes and methods of the present disclosure. While various examples have been discussed in the disclosure as currently considered useful embodiments of the invention, it should be understood that such details are provided for illustrative purposes only. The appended claims are not limited to the disclosed embodiments, and instead, the claims are intended to cover all modifications and equivalent combinations within the scope and essence of the embodiments disclosed in the present disclosure. For example, although the described system components may be implemented through a hardware device, they may also be realized solely through a software solution, such as installing the described system on an existing processing or mobile device.

Similarly, it should be noted that, for the sake of simplifying the presentation of embodiments disclosed in the present disclosure and aiding in understanding one or more embodiments of the present disclosure, various features have been sometimes combined into a single embodiment, drawing, or description. However, this manner of disclosure does not imply that the features required by the claims are more than the features mentioned in the claims. In fact, the features of the embodiments are less than all the features of the single embodiment disclosed in the foregoing disclosure.

In some embodiments, numeric values describing the composition and quantity of attributes are used in the description. It should be understood that such numeric values used for describing embodiments may be modified with qualifying terms such as “about,” “approximately” or “generally”. Unless otherwise stated, “about,” “approximately” or “generally” indicates that a variation of +20% is permitted in the described numbers. Accordingly, in some embodiments, the numerical parameters used in the disclosure and claims are approximations, which can change depending on the desired characteristics of the individual embodiment. In some embodiments, the numerical parameters should take into account a specified number of valid digits and employ a general manner of bit retention. Although the numerical ranges and parameters used in some embodiments of the present disclosure to confirm the breadth of the range are approximations, in specific embodiments, such numerical values are set as precisely as practicable.

With respect to each of the patents, patent applications, publications of patent applications, and other material, such as articles, books, specifications, publications, documents and the like, cited in the present disclosure, the entire contents thereof are hereby incorporated herein by reference. Application history documents that are inconsistent with the contents of the present disclosure or that create conflicts are excluded, as are documents (currently or hereafter appended to the present disclosure) that limit the broadest scope of the claims of the present disclosure. It should be noted that in the event of any inconsistency or conflict between the descriptions, definitions, and/or use of terminology in the materials appended to the present disclosure and the contents described herein, the descriptions, definitions, and/or use of terminology in the present disclosure shall prevail.

In closing, it should be understood that the embodiments described in the present disclosure are used only to illustrate the principles of the embodiments of the present disclosure. Other deformations may also fall within the scope of the present disclosure. Therefore, by way of example and not limitation, alternative configurations of the embodiments disclosed in the present disclosure may be considered consistent with the teachings of the present disclosure. Accordingly, the embodiments described in the present disclosure are not limited to the explicitly introduced and described embodiments in the present disclosure.

What is claimed is:

1. A variable pathlength spectrophotometer for a liquid contained in a bioreactor, comprising:
a light source, to emit a first light;
an entrance slit, to provide a narrow opening for the first light to pass;
a monochromator, to separate the first light and generate a plurality of lights with different wavelengths;
a wavelength selector, to select a second light with a narrow range of wavelengths from the plurality of lights with different wavelengths;
wherein, the narrow range of wavelengths is selected based on a target substance whose concentration is to be measured;
a photodetector, to measure an absorbance of the second light by a sample of liquid;
wherein, the sample of liquid is placed in between the wavelength selector and the photodetector;
wherein, a concentration of the target substance in the sample of liquid is deduced from the absorbance;
wherein, the photodetector is movable along a direction of the second light, so that a distance the second light travels through the sample of liquid, which is a pathlength of the spectrophotometer, is adjustable.

2. The variable pathlength spectrophotometer as in claim 1, which is detachably attached to a port located on an inner surface of a top or a side wall of the bioreactor.

3. The variable pathlength spectrophotometer as in claim 1, which is detachably attached to a port located on an inner wall of a pathway of the bioreactor.

4. The variable pathlength spectrophotometer as in claim 1, further comprising a chamber with two or more ends, allowing the sample of liquid to enter and exit the chamber.

5. The variable pathlength spectrophotometer as in claim 1, which is immersed in the liquid and rotates about a central axis of the bioreactor.

6. The variable pathlength spectrophotometer as in claim 5, wherein the light source, the entrance slit, the monochromator, and the wavelength selector are placed in a first enclosure, wherein the liquid is not able to enter the first enclosure.

7. The variable pathlength spectrophotometer as in claim 1, which is disposable or has disposable parts.

8. The variable pathlength spectrophotometer as in claim 1, wherein a reading of the spectrophotometer is displayed on a screen connected to the spectrophotometer or sent to a computing device via wireless or wired connection.

9. A bioreactor, comprising:
a container, to hold a liquid;
wherein, the liquid includes a target substance;
an agitator located inside the container, to stir and mix the liquid;
a variable pathlength spectrophotometer attached to or placed in the bioreactor, including:
a light source, to emit a first light;
an entrance slit, to provide a narrow opening for the first light to pass;
a monochromator, to separate the first light and generate a plurality of lights with different wavelengths;
a wavelength selector, to select a second light with a narrow range of wavelengths from the plurality of lights with different wavelengths;
wherein, the narrow range of wavelengths is selected based on a target substance whose concentration is to be measured;
a photodetector, to measure an absorbance of the second light by a sample of liquid;
wherein, the sample of liquid takes up a space between the wavelength selector and the photodetector;
wherein, the concentration of the target substance in the sample of liquid is deduced from the absorbance;
wherein, the photodetector is movable along a direction of the second light, so that a distance the second light travels in the sample of liquid, which is a pathlength of the spectrophotometer, is adjustable.

10. The bioreactor in claim 9, further comprising:
one or more sensors attached to one or more ports located on an inner surface of a top or a side wall of the container to respectively measure one or more attributes of the liquid.

11. The bioreactor in claim 9, wherein the variable pathlength spectrophotometer is detachably attached to a port located on an inner surface of a top or a side wall of the container.

12. The bioreactor in claim 9, wherein the variable pathlength spectrophotometer is disposable or has disposable parts.

13. The bioreactor in claim 9, further comprising a screen,
wherein a reading of the variable pathlength spectrophotometer is displayed on the screen or sent to a computing device via wireless or wired connection.

14. The bioreactor in claim 9, wherein the target substance is monoclonal antibodies (mAbs).

15. The bioreactor in claim 9,
wherein, the container includes a pathway;
wherein, a portion of the liquid passes through the pathway;
wherein, the variable pathlength spectrophotometer is attached to a port located on an inner surface of the pathway.

16. The bioreactor in claim 9, wherein the variable pathlength spectrophotometer is immersed in the liquid and rotates about a first central axis of the container.

17. The bioreactor in claim 16, wherein the variable pathlength spectrophotometer includes a first enclosure housing the light source, the entrance slit, the monochromator, and the wavelength selector, wherein the liquid is not able to enter the first enclosure.

18. The bioreactor in claim 16, wherein a second central axis of the variable pathlength spectrophotometer is aligned with a radius of the container.

19. The bioreactor in claim 16, wherein a second central axis of the variable pathlength spectrophotometer is vertical.

20. The bioreactor in claim 9, wherein the variable pathlength spectrophotometer further includes a chamber with two or more ends, allowing the sample of liquid to enter and exit the chamber.
